(19) United States
(12) Patent Application Publication
(10) Pub. No.: US 2007/0007387 A1
(43) Pub. Date: Jan. 11, 2007

(54) Strut extender for landing gear snow skis

(75) Inventors: Andrew R. Zimmerle, Mesa, AZ (US); Timothy R. Hillsamer, Mesa, AZ (US)

Correspondence Address: THOMPSON COBURN, LLP, ONE US BANK PLAZA, SUITE 3500, ST LOUIS, MO, 63101, US

(73) Assignee: The Boeing Company

(21) Appl. No.: 11/174,780

(22) Filed: Jul. 5, 2005

(51) Int. Cl. B64C 25/52

(52) U.S. Cl. 244/108

(57) ABSTRACT

A landing gear strut extender apparatus and its method of use adjust the length of a shock absorbing strut to facilitate the attachment of the strut between an aircraft landing gear and a snow ski. The apparatus is specifically designed for holding the strut in a desired extended (or retracted) length and is then used to attach the strut held at the desired length to an aircraft landing gear that has been fit with a snow ski.

### BACKGROUND OF THE INVENTION

(1) Field of the Invention

The present invention pertains to an apparatus and its method of use in adjusting and holding a length of a shock absorbing strut for attaching the strut between an aircraft landing gear and a snow ski. In particular, the present invention pertains to an apparatus specifically designed for holding the shock absorbing strut in a desired extended (or retracted) length, and the method of using the apparatus to attach the strut held at the desired length to an aircraft landing gear that has been fit with a snow ski.

(2) Description of the Related Art

Various different types of aircraft, including fixed-wing aircraft and rotary wing aircraft are used in all seasons and climates. When used in the winter season or in colder climates, where there is the potential for snow cover over a landing strip or landing area of the aircraft, the landing gear of the aircraft are often equipped with snow skis that support the aircraft on the surface of the snow and prevent the landing gear of the aircraft from penetrating deeply into the snow.

A typical snow ski is attached to the aircraft by pivot connections at the wheel axle of the aircraft landing gear. The pivot connections enable the snow ski to pivot about the wheel axle. The typical snow ski has a length between a forward edge of the snow ski that projects forwardly of the landing gear wheel, and a rearward edge of the snow ski that projects rearwardly of the landing gear wheel. The snow ski often has a lateral width that is greater than the width of the landing gear wheel. An opening is provided through a central portion of the snow ski and the landing gear wheel is positioned in this opening when the snow ski is attached to the landing gear.

With the snow ski being connected by a pivot connection to the aircraft landing gear, it is necessary that a strut be connected between the landing gear and the forward edge of the snow ski. The strut maintains the forward edge of the snow ski at a desired orientation relative to the landing gear to ensure that the snow ski forward edge is directed upwardly when the aircraft is taking off from the snow covered surface or landing on the snow covered surface. This prevents the forward edge of the snow ski from digging into the snow cover as the aircraft lands or takes off.

The typical snow ski strut is comprised of a cylinder and a rod that extends into one end of the cylinder for reciprocating movement of the rod relative to the cylinder. The cylinder contains a pair of springs or other equivalent means of resisting movement of the rod from an at rest position of the rod relative to the cylinder. The end of the rod inside the cylinder is connected between the first and second springs. Pulling the rod from the cylinder compresses one of the springs and stretches the second spring. Pushing the rod into the cylinder stretches the one spring and compresses the second spring. Thus, the springs bias the rod to the at rest position relative to the cylinder. The spring bias on the rod also pulls upwardly on the forward edge of the snow ski to orient the snow ski in its upward orientation relative to the aircraft landing gear.

In installing the snow ski on the aircraft landing gear with the aircraft sitting on the surface of the landing strip or landing area, the surface of the landing strip or landing area prevents the snow ski from being pivoted freely relative to the landing gear. This can prevent the forward edge of the snow ski from being positioned in its desired forward upwardly oriented position relative to the landing gear. It is therefore necessary to extend the length of the snow ski strut to connect the strut between the landing gear and the forward edge of the snow ski. This requires that the strut rod be extended from the strut cylinder against the bias of the strut springs while simultaneously attaching the strut between the landing gear and the snow ski. Performing this attachment procedure is often difficult and time consuming.

An apparatus that could be used to hold the snow ski strut at its adjusted length while the strut is attached between the aircraft landing gear and the forward edge of the snow ski would facilitate the assembly of the strut to the aircraft landing gear and snow ski.

### SUMMARY OF THE INVENTION

The present invention provides an apparatus for adjusting the length of a landing gear snow ski strut from the at rest position of the strut rod and cylinder and holding the strut at the adjusted length, and a method of using the apparatus to attach the strut between an aircraft landing gear and a forward edge of a snow ski. The apparatus is comprised of a minimum number of component parts and is easily operated in holding the snow ski strut when using the apparatus to attach the strut between the aircraft landing gear and the snow ski.

The apparatus is basically comprised of first and second elongate arms, with each arm having opposite proximal and distal ends. The proximal ends of the two arms are connected together by a pivot connection that holds the two arms in a general V-shaped configuration. The two arms are substantially identical, and the lengths of the two arms are reversed when connected together.

A manually operable mechanism is connected between the two arms with the mechanism extending across the V-shaped configuration of the arms. Operation of the mechanism selectively pivots the arms about their pivot connection moving the distal ends of the arms away from each other, and moving the distal ends of the arms toward each other.

Strut connectors are provided at the distal ends of the first and second arms. The strut connector of the first arm is adapted to be removably attached to the cylinder of the snow ski strut. The strut connector of the second arm is adapted to be removably attached to the rod of the snow ski strut.

In use of the apparatus of the invention in adjusting and holding the length of the snow ski strut, the connector of the first arm is removably attached to the strut cylinder and the connector of the second arm is removably attached to the strut rod. The mechanism is then operated to cause the pair of arms to pivot about the pivot connection at the arm proximal ends causing the arms to move away from each other at the distal ends. This causes the connectors to pull the strut rod from the strut cylinder against the bias of the strut springs. The operation of the mechanism is continued, causing the arms to pivot away from each other and the strut rod to be pulled from the strut cylinder until the strut rod is extended a desired extent from the strut cylinder to enable the strut to be easily connected between the landing gear and snow ski of the aircraft. When the strut is connected to the landing gear and the snow ski, the mechanism is operated to cause the arms to pivot toward each other. This releases the connector of the first arm from the strut cylinder and releases the connector of the second arm from the strut rod end and enables removal of the apparatus from the strut.

### BRIEF DESCRIPTION OF THE DRAWING FIGURES

Further features of the invention are set forth in the following detailed description of the preferred embodiment of the invention, and in the following drawing figures wherein:

FIG. 1 is a side perspective view of the apparatus of the invention;

FIG. 2 is a view of the apparatus similar to FIG. 1, showing the apparatus connected to a snow ski strut; and,

FIG. 3 is a view showing the method of using the apparatus of the invention in attaching the snow ski strut between an aircraft landing gear and a snow ski.

### DETAILED DESCRIPTION OF THE PREFERRED EMBODIMENT

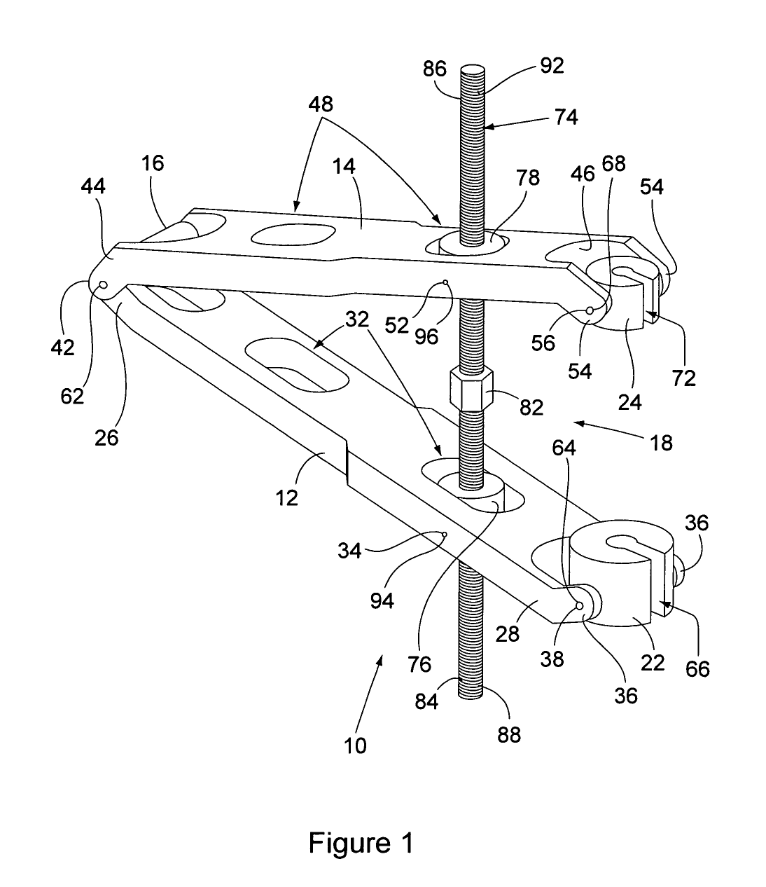

FIG. 1 shows the snow ski strut extender apparatus 10 of the present invention. As shown in FIG. 1, the apparatus 10 is constructed of a minimum number of parts that enable the apparatus to be easily operated. The apparatus 10 is basically comprised of a pair of first and second arms 12, 14, a pivot connection 16 between the arms, a mechanism 18 that extends between the arms and is used to move the arms relative to each other, and a pair of strut connectors 22, 24 attached to the pair of arms. In the preferred embodiment of the apparatus, each of the component parts is constructed of a rigid material, for example a metal, to enhance the strength of the apparatus. However, other equivalent materials may also be used.

The first arm 12 of the pair of arms has a longitudinal length that extends between a proximal end 26 and an opposite distal end 28 of the arm. The arm proximal end 26 has a reduced lateral width compared with the lateral width of the remainder of the arm length. A plurality of oblong holes 32 extend through the arm 26 and are spatially arranged along the arm length. Coaxially aligned pivot holes 34 extend laterally through the arm and intersect one of the oblong holes 32. A pair of fork prongs or tines 36 project outwardly from the arm distal end 28. The prongs 36 have coaxially aligned pivot holes 38 that extend laterally through the prongs.

The second arm 14 is constructed in basically the same manner as the first arm 12 described above. The second arm 14 is substantially identical to the first arm, but the orientation of the second arm 14 is the reverse of that of the first arm 12 in the apparatus. With the arms 12, 14 reversed, the second arm 14 has a pair of prongs 42 that project outwardly from the arm proximal end 44. A lateral spacing between the second arm proximal prongs 42 is dimensioned to receive the proximal end 26 of the first arm 12 between the prongs 42. The second arm 14 also has a longitudinal length that extends from the arm proximal end 44 to an opposite distal end 46 of the arm. Oblong holes 48 extend through the second arm 14. Coaxially aligned pivot holes 52 also extend laterally through the second arm 14 and intersect one of the oblong holes 48. A pair of prongs 54 projects outwardly from the second arm distal end 46. The second arm prongs 54 also have coaxially aligned pivot holes 56 that extend laterally through the prongs.

The pivot connection 16 connects the proximal ends 26, 44 of the two arms, holding the two arms in a V-shaped configuration as shown in FIG. 1. The pivot connection 16 can be provided by a pivot pin 62 that extends through laterally aligned coaxial holes in the proximal ends 26, 44 of the two arms. Other equivalent means can be employed to provide the pivot connection 16 between the two arms 12, 14. The pivot connection 16 enables the distal ends 28, 46 of the two arms 12, 14 to be selectively pivoted toward and away from each other.

The first strut connector 22 is connected between the first arm prongs 36 for pivoting movement of the strut body connector 22 relative to the first arm 12. The first connector 22 has a generally cylindrical exterior configuration. A pair of coaxially aligned connector pins 64 project from diametrically opposite sides of the first connector 22. The pins 64 extend into the first arm prong pivot holes 38, mounting the first connector 22 on the first arm distal end 28 for pivoting movement of the connector relative to the first arm 12. A slot or opening 66 is formed into the first connector 22. The opening 66 is configured to receive an end of the cylinder of the aircraft snow ski strut. This enables the first connector 22 and the first arm distal end 28 to be removably attached to a first portion of the snow ski strut, i.e. the cylinder or body of the snow ski strut.

The second connector 24 is constructed in a similar manner to that of the first connector 22, but at a smaller scale. The second connector 24 is also constructed with a pair of coaxially aligned connector pins 68 that project from diametrically opposite sides of the second connector. The pins 68 extend into the prong pivot holes 56 of the second arm 14, thereby mounting the second connector 24 to the second arm distal end 46 for pivoting movement of the second connector 24 relative to the second arm 14. A slot or opening 72 is formed into the second connector 24. The opening 72 has a configuration that is complementary to an end of the rod of the snow ski strut. Thus, the configuration of the second opening enables the second connector 24 and the second rod distal end 46 to be removably attached to a second portion of the snow ski strut, i.e. the strut rod.

The mechanism 18 that selectively pivots the first and second arms 12, 14 toward and away from each other about the pivot connection 16 can be anyone of various different equivalent types of mechanisms that are capable of performing this method. The mechanism 18 shown is constructed of a screw threaded rod 74 and a pair of internally screw threaded nuts 76, 78.

The rod 74 has a hexagonal head 82 at an intermediate position of the rod length. The head 82 is configured to be engaged by a wrench that is used to turn the rod 74 in opposite directions. The head 82 divides the rod into first 84 and second 86 rod portions that extend from opposite ends of the head 82. The rod first portion 84 has external screw threading 88 and the rod second portion 86 has external screw threading 92. The first portion screw threading 88 is opposite the second portion screw threading 92. For example, the screw threading of the first portion 88 is right hand screw threading, and the screw threading of the second portion 92 is left hand screw threading.

The first nut 76 of the mechanism 18 has an interior bore with internal screw threading that is complementary to the screw threading 88 of the rod first portion 84. The rod first portion 84 is screw threaded through the interior bore of the first nut 76. Thus, the first nut 76 is mounted on the rod first portion 84 for adjustable movement of the first nut 76 along the rod first portion 84 in response to rotation of the rod in opposite directions.

In a like manner, the second nut 78 has an interior bore with internal screw threading that is complementary to the screw threading of the rod second end portion 86. The rod second end portion 86 is screw threaded through the interior bore of the second nut 78. Thus, the second nut 78 is mounted on the rod second portion 86 for adjustable movement of the second nut 76 along the rod second portion 86 in response to rotation of the rod in opposite directions.

A pair of coaxial pivot pins 94 project from diametrically opposite sides of the first nut 76. The first nut is positioned in one of the oblong holes 32 of the first arm 12 with the first nut pivot pins 94 extending into the pivot holes 34 of the first arm. This mounts the first nut 76 on the first arm 12 for pivoting movement of the first nut 76 relative to the first arm 12.

The second nut 78 is also provided with a pair of coaxial pivot pins 96 that project from diametrically opposite sides of the second nut. The second nut 78 is positioned in an oblong hole 48 of the second arm 12 with the diametrically opposite second nut pivot pins 96 extending into the pivot holes 52 of the second arm. This mounts the second nut 78 on the second arm 14 for pivoting movement of the second nut 78 relative to the second arm 14.

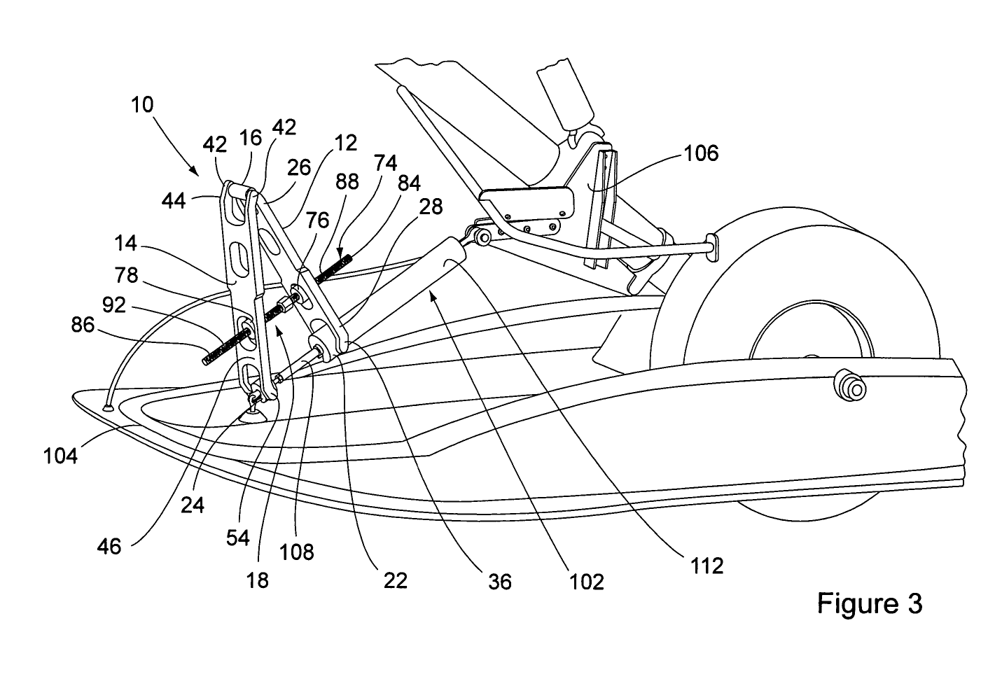

FIG. 3 illustrates the use of the apparatus 10 in installing a snow ski strut 102 between a snow ski 104 and a landing gear 106 of an aircraft. The apparatus 10 is used to extend or adjust the overall length of the strut 102, and to hold the strut at its desired length for attaching opposite ends of the strut to the snow ski 104 and the landing gear 106.

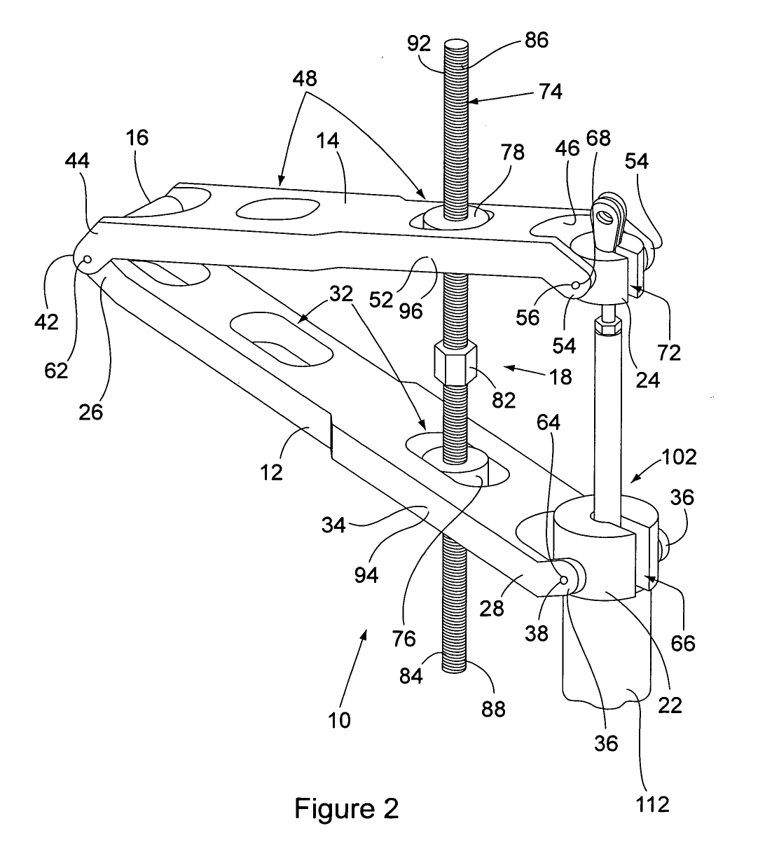

In use of the apparatus 10, the mechanism 18 is manually operated by connecting a wrench to the rod head 82 and turning the head 82 in a desired direction to increase or decrease the distance between the distal ends 28, 46 of the apparatus arms 12, 14. This adjustment is made to position the two connectors 22, 24 at positions where they can be removably attached to the snow ski strut cylinder 112 and rod 108 at the positions shown in FIG. 2. The attachment of the apparatus 10 to the strut 102 is made with the strut rod 108 and cylinder 112 in their relative at rest positions. As shown in FIG. 2, the first strut connector 22 on the first arm 12 is removably attached to the strut cylinder 112 and the second strut connector 24 on the second arm 14 is removably attached to the strut rod 108. Again, these removable connections between the apparatus 10 and the strut 102 are made while the strut rod 118 and strut cylinder 112 are at their relative at rest positions (i.e. their retracted positions).

The mechanism 18 of the apparatus is then operated to cause the pair of arms 12, 14 to pivot about the pivot connection 16 at the arm proximal ends, causing the arms to move away from each other or toward each other. This in turn adjusts the distance between the first strut connector 22 and the second strut connector 24, respectively increasing or decreasing the distance. The movement of the connectors 22, 24 adjusts the overall length of the snow ski strut 102. The operation of the mechanism 18 is continued, causing the arms 12, 14 to move relative to each other and adjusting the overall length of the strut 102 by pulling the strut rod 108 from the strut cylinder 112, or releasing the rod 108 into the cylinder 112 against the bias of the strut springs. This adjusts the overall length of the strut 102 to a desired length that enables the strut to be easily connected between the landing gear 106 and the snow ski 104 of the aircraft. The screw thread engagement between the rod ends 84, 86 and the arm nuts 76, 78 enables a continuous adjustment of the overall length of the strut 102, as opposed to a stepwise adjustment.

When the strut 102 is connected between the landing gear 106 and the snow ski 104, the mechanism 18 is then again operated to cause the arms 12, 14 to pivot toward each other. This releases the strut connectors 22, 24 from their attachment to the strut cylinder 112 and the strut rod 108 and enables removal of the apparatus 10 from the strut 102.

Although the apparatus and its method of use of the invention have been described above by reference to a specific embodiment, it should be understood that modifications and variations could be made to the apparatus and method without departing from the intended scope of the following claims.

1. An apparatus for adjusting a length of a landing gear strut, the apparatus comprising:
a first arm having a length with opposite proximal and distal ends, the first arm distal end being adapted for removable attachment to a first portion of the landing gear strut;
a second arm having a length with opposite proximal and distal ends, the second arm distal end being adapted for removable attachment to a second portion of the landing gear strut; and,
a mechanism connected to the first arm and the second arm, the mechanism being operable to selectively move the first and second arm distal ends toward each other and away from each other.

2. The apparatus of claim 1, further comprising:
the first and second arms being substantially identical; and,
the first arm proximal end being operatively connected to the second arm proximal end.

3. The apparatus of claim 1, further comprising:
a pivot connection connecting the first arm proximal end to the second arm proximal end.

4. The apparatus of claim 1, further comprising:
the mechanism including a screw threaded rod that extends between the first arm and the second arm

5. The apparatus of claim 4, further comprising:
the rod having a length with opposite first and second end portions, the rod first end portion having right hand screw threading and the rod second end portion having left hand screw threading.

6. The apparatus of claim 4, further comprising:
an internally screw threaded nut mounted on the first arm for pivoting movement of the nut on the first arm; and,
the rod being screw threaded into the nut on the first arm.

7. The apparatus of claim 6, further comprising:
an internally screw threaded nut mounted on the second arm for pivoting movement of the nut on the second arm; and,
the rod being screw threaded into the nut on the second arm.

8. The apparatus of claim 1, further comprising:
a first connector mounted on the first arm distal end for pivoting movement of the first connector on the first arm, the first connector being adapted for attachment to the first portion of the landing gear strut.

9. The apparatus of claim 8, further comprising:
a second connector mounted on the second arm distal end for pivoting movement of the second connector on the second arm,
the second connector being adapted for attachment to the second portion of the landing gear strut.

10. The apparatus of claim 8, further comprising:
the first connector having a slot that is dimensioned to removably receive the first portion of the landing gear strut in the first connector slot.

11. The apparatus of claim 9, further comprising:
the second connector having a slot that is dimensioned to removably receive the second portion of the landing gear strut in the second connector slot.

12. An apparatus for adjusting a length of a landing gear strut having a cylinder and a rod that is mounted in the cylinder for reciprocating movement, the apparatus comprising:
a first arm having a length with opposite proximal and distal ends, the first arm distal end being adopted for removable attachment to the strut cylinder;
a second arm having a length with opposite proximal and distal ends, the second arm distal end being adapted for removable attachment to the strut rod; and,
a mechanism connected to the first arm and the second arm, the mechanism being operable to selectively move the first and second arms away from each other and toward each other.

13. The apparatus of claim 12, further comprising:
the first and second arms being substantially identical; and,
the first arm proximal end being operatively connected to the second arm proximal end.

14. The apparatus of claim 12, further comprising:
a pivot connection connecting the first arm proximal end to the second arm proximal end.

15. The apparatus of claim 12, further comprising:
the mechanism including a screw threaded rod that extends between the first arm and the second arm

16. The apparatus of claim 15, further comprising:
the rod having a length with opposite first and second end portions, the rod first end portion having right hand screw threading and the rod second end portion having left hand screw threading.

17. The apparatus of claim 15, further comprising:
an internally screw threaded nut mounted on the first arm for pivoting movement of the nut on the first arm; and,
the rod being screw threaded into the nut on the first arm.

18. The apparatus of claim 17, further comprising:
an internally screw threaded nut mounted on the second arm for pivoting movement of the nut on the second arm; and,
the rod being screw threaded into the nut on the second arm.

19. A method of adjusting a length of a landing gear strut comprising:
providing an apparatus with first and second arms having opposite proximal and distal ends, with the arm proximal ends being operatively connected and the arm distal ends being adapted for removable attachment to respect first and second portions of the strut;
attaching the first arm distal end to the first strut portion and attaching the second arm distal end to the second strut portion; and,
moving the first arm away from the second arm and thereby causing the first strut portion to be moved relative to the second strut portion.

20. The method of claim 19, further comprising:
providing a mechanism between the first and second arms that is operable to move the first and second arms selectively toward and away from each other; and
operating the mechanism to move the first arm relative to the second arm.
